(19) United States
(12) Patent Application Publication
(10) Pub. No.: US 2012/0057481 A1
(43) Pub. Date: Mar. 8, 2012

(54) SYSTEM AND METHOD FOR MEASURING ROUND TRIP TIME BASED ON WIRELESS LOCAL AREA NETWORK

(75) Inventor: Dong Kyoo KIM, Yeongi-gun (KR)

(73) Assignee: ELECTRONICS AND TELECOMMUNICATIONS RESEARCH INSTITUTE, Daejeon (KR)

(21) Appl. No.: 13/226,858

(22) Filed: Sep. 7, 2011

(30) Foreign Application Priority Data
Sep. 7, 2010 (KR) 10-2010-0087649
Jun. 23, 2011 (KR) 10-2011-0061089

(51) Int. Cl. H04W 24/00

(52) U.S. Cl. 370/252

(57) ABSTRACT

A RTT measurement system includes first and second signal time measuring devices respectively connected to two wireless LAN devices and a RTT estimator. Each one of the first and second signal time measuring devices senses a transmitted signal from a corresponding WLAN device and a corresponding received signal and measures a signal time difference between the transmitted signal and the received signal. The RTT estimator estimates a RTT using the measured signal time differences at the first and second signal time measuring devices.

### CROSS-REFERENCE TO RELATED APPLICATION

This application claims priority to and the benefit of Korean Patent Application Nos. 10-2010-0087649 and 10-2011-0061089 filed in the Korean Intellectual Property Office on Sep. 7, 2010 and Jun. 23, 2011, the entire contents of which are incorporated herein by reference.

### BACKGROUND OF THE INVENTION

(a) Field of the Invention

The present invention relates to a system and method for measuring a round trip time (RTT) based on a wireless local area network (WLAN), and particularly, to a RTT measurement technology used in a WLAN based positioning.

(b) Description of the Related Art

Positioning using a wireless local area network (WLAN) may include received signal strength (RSS) based positioning, angle of arrival (AoA) based positioning, and round trip time (RTT) based positioning.

The RSS based positioning may use a signal transmission distance to estimate a position of a target object. In order to calculate the signal transmission distance, the RSS bases positioning measures signal strength of a received signal and estimates signal attenuation based on the measured signal strength. Based on the signal attenuation, the signal transmission distance is calculated to estimate the position of the target object. The RSS based positioning may also use a signal attenuation value or a pattern of signal attenuation values to estimate a position of a target object. The RSS based positioning has a merit of easy implementation in a WLAN device. The RSS based positioning, however, has demerits of low accuracy and low performance as compared to the AoA based positioning and the RTT based positioning.

The AoA based positioning measures an angle of arrival (AoA) of a signal received at an antenna having a known position. The AoA based positioning analyzes a signal propagation path based on the measured AoA and estimates a position of a target object based on the signal propagation path. Lately, a Multiple Input Multiple Output (MIMO) based WLAN device has been introduced and popularly used. The AoA based positioning could be implemented in the WLAN device. However, there is a low chance to successfully implement the AoA based positioning in the WLAN device because a WLAN device must support a corresponding technology. The AoA based positioning also has a drawback that accuracy is seriously deteriorated in a multipath environment.

The RTT based positioning is the most used method in a global positioning system (GPS) and IEEE802.15.4a. The RTT based positioning measure a round trip time (RTT) between two WLAN devices by transmitting and receiving signal between the WLAN devices and estimates a distance between the WLAN devices based on RTT. Based on the measured distance, the RTT based position estimates a position of a corresponding WLAN device. A distance between two WLAN devices may be calculated by multiplying a RTT and a propagation speed.

The RTT based positioning can estimate a position very accurately in an environment where a line of sight (LOS) for positioning is secured. Accordingly, RTT based positioning in an application layer, RTT based positioning in a network layer, and RTT based positioning in a link layer have been introduced. The RTT based positioning may be easily applicable to a WLAN device. However, the RTT based positioning cannot accurately measure a RTT in an application layer and a network layer due to time delay generated during data transmission between a media access control (MAC) layer and a physical layer. The RTT based positioning in a link layer has better performance as compared to the RTT positioning in an application layer and a network layer. However, the RTT based positioning in a link layer cannot be implemented in a typical WLAN device because it requires hardware modification of the typical WLAN device.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for measuring a round trip time based on a wireless local area network having advantages of improving accuracy of round trip time measurement without changing hardware of a WLAN device.

An exemplary embodiment of the present invention provides a system for measuring a round trip time (RTT) based on a wireless location area network (WLAN). The RTT measurement system includes first and second signal time measuring devices and a RTT estimator. The first and second signal time measuring devices are respectively connected to two WLAN devices that perform WLAN communication. Each one of the first and second signal time measuring devices measures a signal time difference between a transmitted signal from one of the two WLAN devices and a corresponding received signal at the other. The RTT estimator estimates a RTT using the measured signal time differences of the first and the second signal-time measuring devices.

Each one of the first and the second signal time measuring devices includes a reception time detector, a signal detector, and a time calculator. The reception time detector detects a signal transmission time of the transmitted signal and a signal reception time of the received signal. The signal detector determines a type of the transmitted signal and the received signal. The time calculator calculates a signal time difference for RTT estimation using the signal transmission time of the transmitted signal and the signal reception time of the received signal and the type of the transmitted signal and the received signal.

Each one of the first and second signal time measuring devices further includes an antenna. The antenna senses a transmitted signal from a corresponding WLAN device and a received signal at a corresponding WLAN device and transfers the sensed signals to the reception time detector.

The signal detector demodulates and decodes the transmitted signal and the received signal to determine the type of the transmitted signal and the received signal. One of the transmitted signal and the received signal includes one of a Probe Request signal and a Probe Response signal. The transmitted signal includes a Probe Response signal when the received signal is a Probe Request signal. The transmitted signal includes an Acknowledgement signal for a Probe Request signal and a Probe Response signal when the received signal is the Probe Response signal.

One of the transmitted signal and the received signal includes one of a request to send (RTS) signal and a Clear To Send (CTS) signal. The transmitted signal includes the CTS signal when the received signal is the RTS signal, and the transmitted signal includes the RTS when the received signal is the CTS signal.

One of the transmitted signal and the received signal includes one of a Command Request signal and a Command Response signal. The transmitted signal includes the Command Response signal when the received signal is the Command Request signal, and the transmitted signal includes the Command Response signal when the received signal is the Command Response signal.

One of the transmitted signal and the received signal includes one of data and an Acknowledgement signal. The transmitted signal includes the Acknowledgement signal when the received signal is the data, and the transmitted signal includes the data when the received signal is the Acknowledgement signal.

Another exemplary embodiment of the present invention provides a method for estimating a round trip time (RTT) using signals transmitted/received between two wireless local area network (WLAN) devices in a RTT measurement system. The RTT measurement method include receiving a transmitted signal of one of the two WLAN devices and a corresponding received signal at each of first and second signal time measuring devices respectively connected to the two WLAN devices; measuring a signal time difference of the transmitted signal and the received signal at each one of the first and second signal time measuring devices; and estimating a RTT using the measured signal time differences of the first and second signal time measuring devices. The measuring a signal time difference may include receiving a transmitted signal of a corresponding WLAN device and a received signal corresponding to the transmitted signal; detecting a signal transmission time of the transmitted signal and a signal reception time of the received signal; and calculating a signal time difference between the signal reception time of the received signal and the signal transmission time of the transmitted signal.

### BRIEF DESCRIPTION OF THE DRAWINGS

FIG. 1 illustrates a system for measuring a round trip time (RTT) based on wireless local area network (WLAN) in accordance with an exemplary embodiment of the present invention.

FIG. 2 to FIG. 4 illustrates exemplary variation of a system for measuring a RTT based on a WLAN. FIG. 5 to FIG. 7 illustrates a method for measuring a round trip time (RTT) in a system for measuring a RTT based on a WLAN. FIG. 8 to FIG. 11 illustrates signals used in a WLAN device and a time difference between the signals.

FIG. 12 illustrates a signal time measuring device in accordance with an exemplary embodiment of the present invention.

FIG. 13 illustrates a method for measuring a signal time value in a signal time measuring device in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout specification and claims, in addition, unless explicitly described to the contrary, the word “comprise” and variations such as “comprises” or “comprising”, will be understood to imply the inclusion of stated elements but not the exclusion of any other elements.

Hereinafter, a system and method for measuring a RTT based on a wireless local area network (WLAN) in accordance with an exemplary embodiment of the present invention will be described with reference to the accompanying drawings.

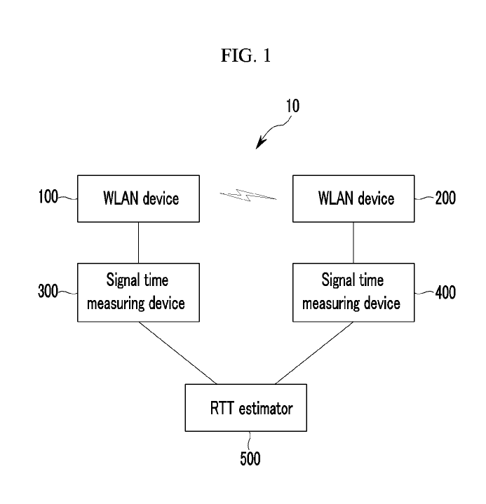

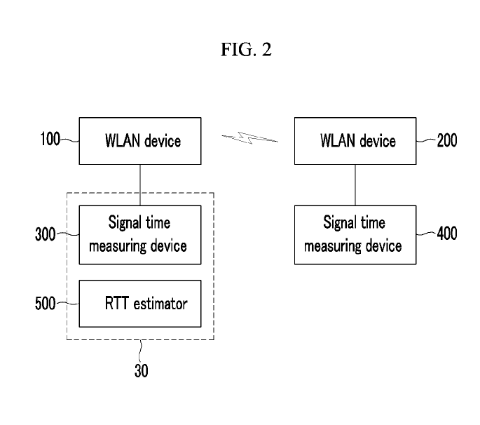

FIG. 1 illustrates a system for measuring a RTT based on a WLAN in accordance with an exemplary embodiment of the present invention, and FIG. 2 to FIG. 4 illustrates exemplary variation of a WLAN-based RTT system.

Referring to FIG. 1, a system 10 for measuring a RTT based on a WLAN may include two Wireless Local Area Network (WLAN) devices 100 and 200, signal-time measuring devices 300 and 400, and a Round Trip Time (RTT) estimator 500.

The WLAN devices 100 and 200 denote a device having a WLAN wireless communication module. For example, the WLAN devices 100 and 200 may be a wireless access point (AP) or a user terminal such as a smart phone and a laptop having a WLAN wireless communication module.

The WLAN devices 100 and 200 may transmit and receive signals using the WLAN wireless communication module.

The signal-time measuring devices 300 and 400 may be directly connected to the WLAN devices 100 and 200 through a wired link or a wireless link. For example, the signal-time measuring devices 300 and 400 may be connected to the WLAN devices 100 and 200 through USB connection or serial connection.

The signal-time measuring devices 300 and 400 may detect a signal transmission time of a transmitted signal and a signal reception time of a corresponding received signal at a physical layer of the WLAN devices 100 and 200.

The signal-time measuring devices 300 and 400 may calculate a time difference between the signal transmission time of each transmitted signal and the signal reception time of each corresponding received signal and provides the calculated signal time different to the RTT estimator 500.

The RTT estimator 500 may estimate a RTT between the WLAN devices 100 and 200 using the signal time difference from the signal time measuring devices 300 and 400.

A distance between the WLAN devices 100 and 200 can be calculated by multiplying the estimated RTT with a propagation speed. Based on the calculated distance between the WLAN devices 100 and 200, a position of a corresponding WLAN device can be estimated.

The RTT estimator 500 may be implemented as software, hardware, or combination thereof according to a purpose of implementation.

The RTT estimator 500, as shown in FIG. 1, may be an independent device separated from the WLAN devices 100 and 200 or from the signal-time measuring devices 300 and 400. The RTT estimator 500 may be implemented in one of the WLAN devices 100 and 200 and the signal-time measuring devices 300 and 400.

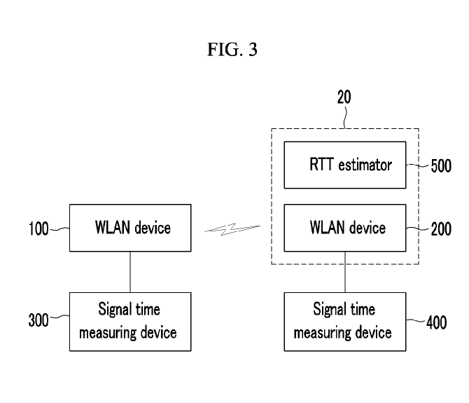

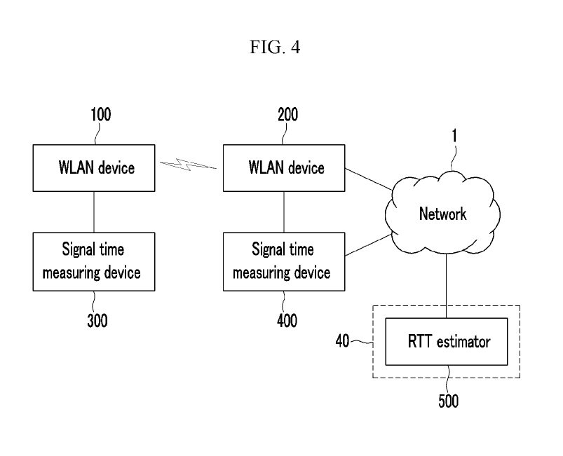

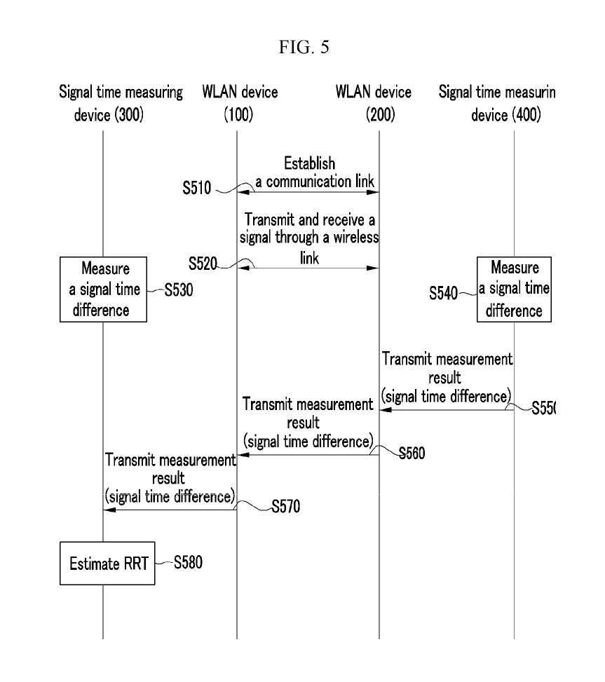

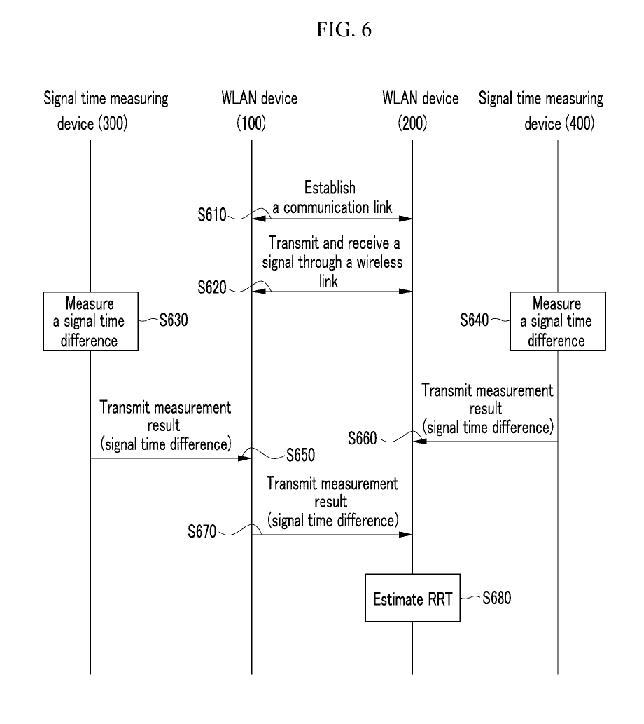

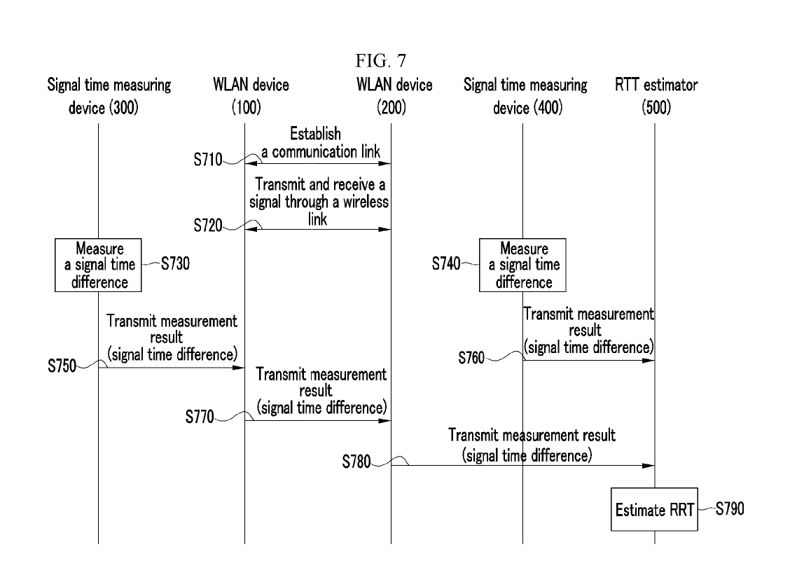

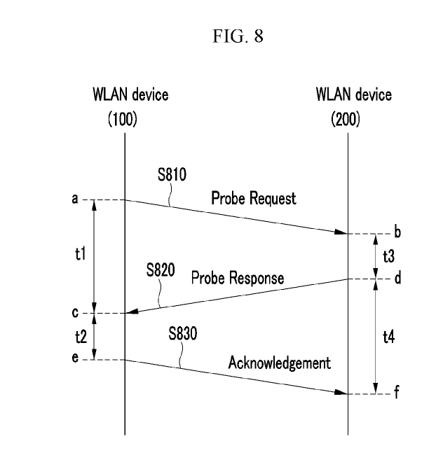

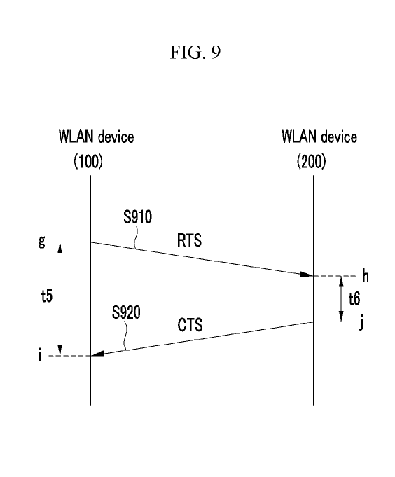

For example, as shown in FIG. 2, the RTT estimator 500 may be implemented as an independent device 30 with the signal-time measuring device 300. As shown in FIG. 3, the RTT estimator 500 may be implemented as an independent device 20 with one of the WLAN devices 100 and 200. Unlikely, the RTT estimator 500 may be implemented as an external device as shown in FIG. 4. The RTT estimator 500 in the external device 40 may be connected to the signal-time measuring device 400 and the WLAN device 200 through a first network 1. The RTT estimator 500 may be directly connected to the signal-time measuring device 300 and the WLAN device 100. In this case, information on a signal time difference between signals measured by the signal-time measuring device 300 may be transferred to the RTT estimator 500 through the WLAN devices 100 and 200. The first network 1 may be a public network such as a wide area network (WAN) and a local area network (LAN). Unlikely, the signal-time measuring devices 300 and 400 may be connected through the first network 1.

Hereinafter, a method for estimating a round trip time (RTT) in accordance with an exemplary embodiment of the present invention will be described in detail with reference to FIG. 5 to FIG. 7.

FIG. 5 to FIG. 7 illustrate methods for estimating a round trip time (RTT), which are performed in the systems for measuring a RTT based on a WLAN of FIG. 2 to FIG. 4.

FIG. 5 illustrates a method for estimating a RTT when a RTT estimator 500 is implemented with a signal-time measuring device 300 as one device as shown in FIG. 2. For convenience, FIG. 5 illustrates a signal-time measuring device 300 as a device including a RTT estimator 500 and the signal-time measuring device 300.

Referring to FIG. 5, the WLAN devices 100 and 200 establish a WLAN wireless link to transmit and receive a signal at step S510. The WLAN devices 100 and 200 transmit and receive a signal through the WLAN wireless link at step S520. The signal-time measuring devices 300 and 400 measure a signal time difference between a transmitted signal and a corresponding received signal based on a signal transmission time of the transmitted signal and a signal reception time of the received signal at a physical layer of the WLAN devices 100 and 200 at steps S530 and S540.

For example, the WLAN device 100 transmits a signal and the WLAN device 200 receives the signal. The WLAN device 200 transmits a response signal to the WLAN device 100 in response to the signal. In this case, the signal-time measuring device 300 receives the signal transmitted from the WLAN device 100 and measures a signal transmission time of the transmitted signal from the WLAN device 100. The signal-time measuring device 400 receives a signal transmitted from the WLAN device 100 at the same time of the WLAN device 200 and measures a signal reception time of receiving the signal. The signal-time measuring device 300 receives the response signal transmitted from the WLAN device 200 at the same time of the WLAN device 100 and measures a signal reception time of the response signal. Then, the signal-time measuring device 300 measures a signal time difference between the signal transmission time of the signal and the signal reception time of the response signal. The signal-time measuring device 400 may also measure a signal time difference using the same method of the signal-time measuring device 300.

The signal-time measuring device 400 transfers the measurement result, information on the signal time difference, to the WLAN device 200 at step S550. The WLAN device 200 transmits the measuring result of the signal-time measuring device 400 to the WLAN device 100 at step S560. The WLAN device 100 transfers the received measuring result to the signal-time measuring device 300 where the RTT estimator 500 is implemented therein at step S570.

The signal-time measuring device 300 measures a RTT of a corresponding signal based on own measurement result and the measurement result of the signal-time measuring device 400 at step S580.

In case of ending the RTT estimation, the WLAN devices 100 and 200 may release the WLAN wireless link.

FIG. 6 illustrates a method for estimating a RTT when a RTT estimator 500 is implemented with a WLAN device 400 as one device as shown in FIG. 3.

For convenience, FIG. 6 illustrates a WLAN device 400 as a device having a RTT estimator 400 and the WLAN device 400.

Referring to FIG. 6, the signal-time measuring devices 300 and 400 estimate signal time differences for estimating a RTT at steps S610-S640 like the method of FIG. 5. The signal-time measuring device 300 transfers the measurement result to the WLAN device 200 through the WLAN device 100 at steps S650 and S670. As described above, the WLAN device 200 includes the RTT estimator 500. The signal-time measuring device 400 transfers the measurement result to the WLAN device 200 at step S660. The WLAN device 200 estimates a RTT using the measurement results from the signal-time measuring devices 300 and 400 at step S680.

FIG. 7 illustrates a method for estimating a RTT when a RTT estimator 500 is implemented as an external device as shown in FIG. 6.

Referring to FIG. 7, the signal-time measuring devices 300 and 400 measure signal time differences for RTT estimation at steps S710-S740 like the method of FIG. 5. The signal-time measuring device 400 transfers the measurement result to the RTT estimator 500 through the first network 1 at step S760.

The signal-time measuring device 300 transfers the measurement result to the WLAN device 100 that is connected to the signal-time measuring device 200 at step S760. The WLAN device 100 transfers the measurement result of the signal-time measuring device 300 to the WLAN device 200 at step S770. Then, the WLAN device 200 transfers the measurement result of the signal-time measuring device 300 to the RTT estimator 500 through the first network 1 at step S780.

The RTT estimator 500 estimates a RTT using the measurement results from the signal-time measuring devices 300 and 400 at step S790.

Hereinafter, signals generally used in the WLAN devices 100 and 200 and a signal time difference thereof for RTT estimation will be described with reference to FIG. 8 to FIG. 11.

FIG. 8 to FIG. 11 illustrates signal time differences of signals used in a WLAN device.

Referring to FIG. 8, the WLAN device 100 may transmit a Probe Request signal to the WLAN device 200 at step S810.

After receiving the Probe Request signal, the WLAN device 200 transmits a Probe Response signal to the WLAN device 100 at step S820. The WLAN device 100 receives the Probe Response signal and transmits an Acknowledgement signal to the WLAN device 200 at step S830.

In this case, the signal-time measuring device 300 receives the Probe Request signal from the WLAN device 100 at a physical layer and measures a signal transmission time (a) of the Probe Request signal. The signal-time measuring device 30 receives the Probe Response signal at the same time of the WLAN device 100 and measures a signal reception time of the Probe Response signal. The signal-time measuring device 300 receives the Acknowledgement signal transmitted from the WLAN device 100 and a signal reception time of the Acknowledgement.

The signal-time measuring device 400 receives the Probe Request signal from the WLAN device 100 at the same time that the WLAN device 200 receives the Probe Request signal and measures a signal reception time (b) of the Probe Request signal. The signal-time measuring device 400 receives a Probe Response signal transmitted from the WLAN device 200 and detects a signal transmission time (d) of the Probe Response signal. The signal-time measuring device 400 receives an Acknowledgement signal transmitted from the WLAN device 100 at the same time of the WLAN device 200 and measures a signal reception time (f) of the Acknowledgement signal.

The signal-time measuring device 300 measures a signal time difference (t1) between the signal transmission time (a) of the Probe Request signal and the signal reception time (d) of the received Probe Response signal. The signal-time measuring device 300 also measures a signal time different (t2) between the signal reception time (d) of the Probe Response signal and the signal transmission time (e) of the Acknowledgement signal. The signal-time measuring device 400 measures a time difference (t3) between the signal reception time (b) of the Probe Request signal and the signal transmission time (d) of the Probe Response signal at a physical layer. The signal-time measuring device 400 also measures a signal time difference (t4) between the signal transmission time (d) of the Probe Response signal and the signal reception time (f) of the Acknowledgement signal.

The signal-time measuring device 300 transfers the measured signal time differences (t1 and t2) to the RTT estimator 500. The signal-time measuring device 400 transfers the measured signal time difference (t3 and t4) to the RTT estimator 500.

Referring to FIG. 9, the WLAN device 100 may transmit a Request To Send (RTS) signal to the WLAN device 200 at step S910 when the WLAN device 100 has data to send. The WLAN device 200 receives the RTS signal and transmits a Clear TO Send (CTS) signal to the WLAN device 100 at step S920.

In this case, the signal-time measuring device 300 measures a signal transmission time (g) of the RTS signal and a signal reception time (i) of the CTS signal at a physical layer using the same method of FIG. 8. The signal-time measuring device 300 measures a signal time difference (t5) between the signal transmission time (g) of the RTS signal and the signal reception time (i) of the CTS signal and transfers the measured signal time difference (t5) to the RTT estimator 500. The signal-time measuring device 400 also measures a signal reception time (h) of the RTS signal and a signal transmission time U) of the CTS signal at a physical layer using the same method of FIG. 8. The signal-time measuring device 400 measures a signal time difference (t6) between the signal reception time (h) of the RTS signal and the signal transmission time (j) of the CTS signal and transfers the signal time difference (t6) to the RTT estimator 500.

Referring to FIG. 10, the WLAN device 100 may transmit a Command Request signal to the WLAN device 200 at step S1010. The WLAN device 200 receives the Command Request signal and transmits a Command Response signal to the WLAN device 100 at step S1020.

In this case, the signal-time measuring device 300 measures a signal transmission time (k) of the Command Request signal and a signal reception time (m) of the Command Response signal at a physical layer. The signal-time measuring device 300 also measures a signal time difference (t7) between the signal transmission time (k) of the Command Request signal and the signal reception time (m) of the Command Response signal and transmits the signal time difference (t7) to the RTT estimator 500. The signal-time measuring device 400 measures a signal reception time (l) of the Command Request signal and a signal transmission time (n) of the Command Request signal at a physical layer. The signal-time measuring device 400 measures a signal time difference (t8) between the signal reception time (l) of the Command Request signal and the signal transmission time (n) of the Command Response signal and transfer the signal time difference (t8) to the RTT estimator 500.

Referring to FIG. 11, after reserving resources for transmitting data, the WLAN device 100 may transmits data to the WLAN device 200 at step S1110. The WLAN device 200 receives the data and transmits an Acknowledgement signal to the WLAN device 100 at step S1120.

In this case, the signal-time measuring device 300 measures a signal transmission time (o) of data and a signal reception time (q) of a corresponding acknowledgement signal at a physical layer, calculates a signal time difference (t9) between the signal reception time (o) and the signal reception time (q), and transmits the calculated signal time difference (t9) to the RTT estimator 500. Furthermore, the signal-time measuring device 400 measures a signal reception time (p) of data and a signal transmission time (r) of a corresponding acknowledgement signal at a physical layer, calculates a signal time difference (t10) between the signal reception time (p) and the signal transmission time (r), and transmits the signal time difference (t10) to the RTT estimator 500.

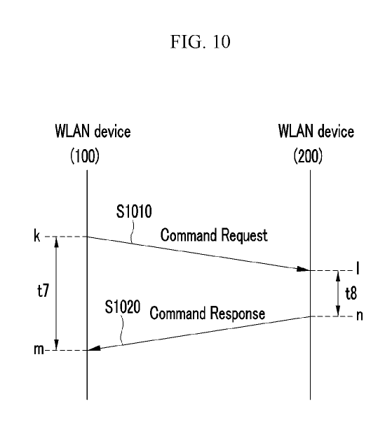

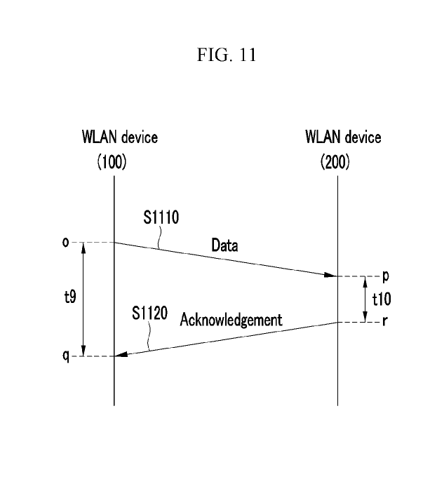

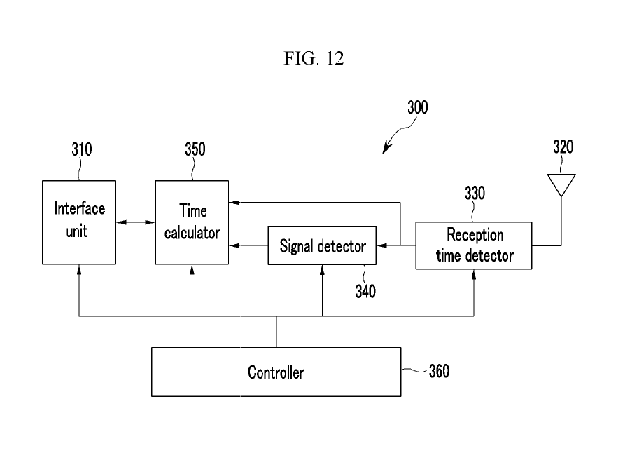

FIG. 12 illustrates a signal-time measuring device in accordance with an exemplary embodiment of the present invention.

Although FIG. 12 illustrates the signal-time measuring device 300 of FIG. 1, the signal-time measuring device 400 also have the same configuration of the signal-time measuring device 300.

Referring to FIG. 12, a signal-time measuring device 300 may include an interface unit 310, an antenna 320, a signal reception time detector 330, a signal detector 340, a time calculator 350, and a controller 360.

The interface unit 310 may be connected to the WLAN device 100 or the communication network 10.

The antenna 320 senses signals that are transmitted or received through the physical layer of the WLAN device 100 and transfers the sensed signals to the signal reception time detector 330.

The signal reception time detector 330 may detect a signal reception time of the sensed signal from the antenna 320 and relay the detected signal to the signal detector 340 and the time calculator 350. For example, the detected signal may be a received baseband signal.

The signal reception time of a received signal means a signal transmission time of a signal transmitted from the WLAN device 100 when the time measuring device receives a signal transmitted from the WLAN device 100. The signal reception time of the received signal may be a signal reception time of a signal received at the WLAN device 100 when the time measuring device receives a signal at the same time of the WLAN 100.

That is, a signal reception time detected at the signal reception time detector 330 may be a signal transmission time of a Probe Request signal shown in FIG. 8 or a signal reception time of a Probe Response signal shown in FIG. 8.

The signal detector 340 determines a type of a corresponding signal from the received baseband signal and transfers the determination result to the time calculator 350. For example, the signal detector 340 determines whether the received baseband signal is one of a Probe Request signal, a Probe Response signal, a RTS signal, a CTS signal, a Command Request signal, a Command Response signal, and an Acknowledgement signal.

The time calculator 350 may calculate a signal time difference according to the type of the corresponding received signal using the signal reception time and the signal transmission time of the corresponding received signal.

For example, in case of a Probe Response signal, the time calculator 350 may calculate signal time differences (t1 and t2) using a signal reception time of a Probe Response signal, a signal transmission time of a Probe Request signal corresponding to the Probe Response signal, and a signal transmission time of an Acknowledgement signal corresponding to the Probe Response signal. Also, the time calculator 350 may calculate a signal time difference (t5) shown in FIG. 9 using a signal reception time of a CTS signal and a signal transmission time of a RTS signal corresponding to the CTS signal when the received signal is the CTS signal.

The time calculator 350 transfers the calculated signal time difference to the RTT estimator 500 through the interface unit 310.

Meanwhile, the signal time difference of the signal time measuring unit 300 transfers the signal time difference to the RTT estimator 500 through an internal interface when the RTT estimator 500 and the signal-time measuring device 300 are implemented as one device.

The controller 360 controls overall operation of the signal-time measuring device 300.

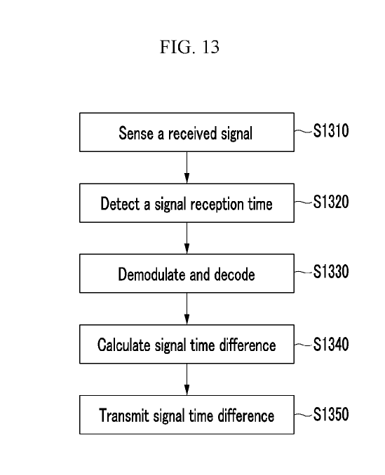

FIG. 13 is a flowchart that illustrates a method for calculating a signal time difference in a signal-time measuring device in accordance with an exemplary embodiment of the present invention.

Referring to FIG. 13, the antenna 320 senses a signal received at a physical layer of the WLAN device 100 at step S1310.

The signal reception time detector 330 detects a signal reception time from the received baseband signal from the antenna 320 at step S1320 and transfers the received baseband signal to the signal detector 340. The signal reception time detector 330 transfers a signal reception time of the received signal to the calculator 350.

The signal detector 340 determines a type of the received signal by demodulating and decoding the received baseband signal at step S1330 and transfer information thereof to the time calculator 350.

The time calculator 350 calculates a signal time difference using the signal reception time of the received signal according to the type of the received signal and a signal reception time of a signal corresponding to the received signal at step S1340.

The time calculator 350 transfers the calculated signal time difference to the RTT estimator 500 at step S1350.

In accordance with an exemplary embodiment of the present invention, a RTT can be measured at a physical layer of a WLAN device without hardware modification of a typical WLAN device. Accordingly, a RTT can be further accurately measured at an application layer, a network layer, and a link layer.

The apparatus and method according to an exemplary embodiment of the present invention described above can be realized as a program performing functions corresponding to configuration elements of the apparatus and method or as a computer readable recording medium storing the program. Since the realization can be easily implemented by those skilled in the art to which the exemplary embodiment of the present invention pertains, further description will not be provided herein.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for measuring a round trip time (RTT) based on a wireless local area network (WLAN), the system comprising:
first and second signal time measuring devices respectively connected to two WLAN devices that perform WLAN communication and each measuring a signal time difference between a transmitted signal from each one of the two WLAN devices and a corresponding received signal at the other; and
a RTT estimator for estimating a RTT using the measured signal time differences of the first and the second signal-time measuring devices.

2. The system of claim 1, wherein each one of the first and the second signal time measuring devices includes:
a reception time detector for detecting a signal transmission time of the transmitted signal and a signal reception time of the received signal;
a signal detector for determining a type of the transmitted signal and the received signal; and
a time calculator for calculating a signal time difference for RTT estimation using the signal transmission time of the transmitted signal and the signal reception time of the received signal and the type of the transmitted signal and the received signal.

3. The system of claim 2, wherein each one of the first and second signal time measuring devices further includes:
an antenna for sensing a transmitted signal from a corresponding WLAN device and a received signal at a corresponding WLAN device and transferring the sensed signals to the reception time detector.

4. The system of claim 2, wherein the signal detector demodulates and decodes the transmitted signal and the received signal to determine the type of the transmitted signal and the received signal.

5. The system of claim 2, wherein one of the transmitted signal and the received signal includes one of a Probe Request signal and a Probe Response signal, and
the transmitted signal includes a Probe Response signal when the received signal is a Probe Request signal, and the transmitted signal includes an Acknowledgement signal for a Probe Request signal and a Probe Response signal when the received signal is the Probe Response signal.

6. The system of claim 2, wherein one of the transmitted signal and the received signal includes one of a request to send (RTS) signal and a Clear To Send (CTS) signal, and
the transmitted signal includes the CTS signal when the received signal is the RTS signal, and the transmitted signal includes the RTS when the received signal is the CTS signal.

7. The system of claim 2, wherein one of the transmitted signal and the received signal includes one of a Command Request signal and a Command Response signal, and
the transmitted signal includes the Command Response signal when the received signal is the Command Request signal, and the transmitted signal includes the Command Response signal when the received signal is the Command Response signal.

8. The system of claim 2, wherein:
one of the transmitted signal and the received signal includes one of data and an Acknowledgement signal, and
the transmitted signal includes the Acknowledgement signal when the received signal is the data, and the transmitted signal includes the data when the received signal is the Acknowledgement signal.

9. The system of claim 1, wherein:
the RTT estimator is implemented in one of the two WLAN devices.

10. The system of claim 1, wherein:
the RTT estimator is implemented together with one of the first and second signal time measuring devices.

11. A method for estimating a round trip time (RTT) using signals transmitted/received between two wireless local area network (WLAN) devices in a RTT measurement system, the method comprising:
receiving a transmitted signal of one of the two WLAN devices and a corresponding received signal at each of first and second signal time measuring devices respectively connected to the two WLAN devices;
measuring a signal time difference of the transmitted signal and the received signal at each one of the first and second signal time measuring devices; and
estimating a RTT using the measured signal time differences of the first and second signal time measuring devices.

12. The method of claim 11, wherein the measuring a signal time difference includes:
receiving a transmitted signal of a corresponding WLAN device and a received signal corresponding to the transmitted signal;
detecting a signal transmission time of the transmitted signal and a signal reception time of the received signal; and
calculating a signal time difference between the signal reception time of the received signal and the signal transmission time of the transmitted signal.

13. The method of claim 12, wherein one of the transmitted signal and the received signal includes one of a Probe Request signal and a Probe Response signal, and
the transmitted signal includes a Probe Response signal when the received signal is the Probe Request signal, and the transmitted signal includes the Probe Request signal and an Acknowledgement signal for the Probe Response signal when the received signal is the Probe Response signal.

14. The method of claim 12, wherein one of the transmitted signal and the received signal includes one of a Request To Send (RTS) signal and a Clear To Send (CTS) signal, and
the transmitted signal includes the CTS signal when the received signal is the RTS signal, and the transmitted signal includes the RTS signal when the received signal is the CTS signal.

15. The method of claim 12, wherein one of the transmitted signal and the received signal includes a Command Request signal and a Command Response signal, and
the transmitted signal includes the Command Response signal when the received signal is the Command Request signal, and the transmitted signal includes the Command Request signal when the received signal is the Command Response signal.

16. The method of claim 12, wherein one of the transmitted signal and the received signal is one of data and an Acknowledgement signal, and
the transmitted signal includes the Acknowledgement signal when the received signal includes the data, and the transmitted signal includes the data when the received signal is the Acknowledgement signal.

17. The method of claim 11, wherein the first and second signal time measuring devices are respectively connected to corresponding WLAN devices through a wired link or a wireless link.

18. The method of claim 11, wherein
at least one of the first and second signal time measuring devices is connected to the RTT estimator through a network.
